(19) United States
(12) Patent Application Publication
(10) Pub. No.: US 2024/0225217 A9
(43) Pub. Date: Jul. 11, 2024

(54) PART OF A LUGGAGE SYSTEM COMPRISING A NATURAL FIBER MATERIAL AND METHOD FOR ITS MANUFACTURE AND REPAIR

(71) Applicant: HS New Travel GmbH, Berlin (DE)

(72) Inventors: Jan Hendrik Roosen, Berlin (DE); Everett Bleakney, Berlin (DE); Jörg Russ, Wilhelmsdorf (DE); Michael Wiesner, Wilhelmsdorf (DE)

(21) Appl. No.: 18/547,024

(22) PCT Filed: Feb. 23, 2022
(86) PCT No.: PCT/EP2022/054556

§ 371 Date: Aug. 18, 2023

(30) Foreign Application Priority Data
Feb. 26, 2021 (DE) 10 2021 201 835.1

(51) Int. Cl. A45C 5/02; A45C 5/03; A45C 5/14; A45C 13/26; B29C 70/20; B29C 70/34; B32B 5/02; B32B 5/12; B32B 5/26; D03D 1/00; D03D 15/217

(52) U.S. Cl. CPC A45C 5/02; A45C 5/03; A45C 5/14; A45C 13/262; B29C 70/202; B29C 70/345; B32B 5/024; B32B 5/12; B32B 5/262; D03D 1/00; D03D 15/217; B29L 2031/7418; B32B 2439/40; D10B 2503/00; D10B 2505/02

(57) ABSTRACT

The present invention relates to a part of a luggage system, in particular a shell of a hard-shell case or trolley, comprising a natural fiber material. The present invention further relates to a method for the manufacture and a method for the repair of such a part. A part of a luggage system is provided which comprises a fiber-reinforced material, wherein the fiber-reinforced material comprises a natural fiber material and a matrix material. The natural fiber material comprises at least one set of unidirectional fibers which are embedded in and/or impregnated with the matrix material.

### PRIORITY CLAIM

This application is a U.S. National Stage filing of International Application No. PCT/EP2022/054556, filed Feb. 23, 2022, titled “PART OF A LUGGAGE SYSTEM COMPRISING A NATURAL FIBER MATERIAL AND METHOD FOR ITS MANUFACTURE AND REPAIR”, which claims the benefit of priority to the German Application No. 102021201835.1, filed Feb. 26, 2021. All of the aforementioned applications are incorporated herein by reference in their entireties.

### TECHNICAL FIELD

The present invention relates to a luggage system or a part of a luggage system, in particular a shell of a hard-shell case or trolley or a part of such a shell, comprising a natural fiber material. The present invention further relates to a method for the manufacture and a method for the repair of such a luggage system or part of a luggage system.

### PRIOR ART

Material fibers of synthetics, carbon or e-glass have been utilized in the rolling luggage industry for decades, both in woven and non-woven patterns suspended in a suitable matrix material, due to their ability to add strength in a number of areas such as the tensile-, tear- and torsional stability of the luggage. While these composite materials can achieve high levels of mechanical performance, they can easily be weakened or broken by poor processing and environmental conditions.

Regardless of cause, should a failure in such a composite shell occur, there is seldom a chance for repair to the shell, rather only replacement. The individual materials that comprise the composite material in the broken shell would need to be separated individually to be recycled via heat or mechanical- or chemical processes in state-of-the-art recycling facilities. Globally, composites are almost never recycled due to the difficulty of separating the contained materials, the energy intensity to perform the separation and the lack of economic incentive to do so.

As the materials comprised in the known composite materials are inorganic and are potentially or already known to be highly damaging to the environment in their extraction and processing, and given that their end of life is almost exclusively landfill, the life cycle assessment for the world's strongest composite materials in the luggage industry is surprisingly brief and with negative impacts on the environment both on the front and back end of their life.

For most consumers, however, ecological sustainability is a key attribute they would like to see advanced in most any product. Often it is expressed that sustainability and durability are opposing ideas at any reasonable cost and that one must be sacrificed for the others, which always leaves the customer with a compromise.

Some consideration to the use of natural fibers was given in document U.S. Pat. No. 3,383,272 A describing a molded rigid product having contoured and non-contoured portions, said product being derived from a resin impregnated fibrous mass comprising a plurality of fibers, in particular jute fibers, that are formed into a porous, interlocked mass by suitable needling or gigging means.

More recently, luggage using flax fibers and bioplastics has been offered by PROJECTKIN ApS, Denmark (website: https://projectkin.com/).

However, there is still a need for luggage that improves on the environmental impact of convention luggage systems while maintaining the stability and strength of known constructions and composite materials.

This problem is addressed and at least partially solved by the different aspects of the present invention.

### SUMMARY OF THE INVENTION

A first aspect of the invention relates to a part of a luggage system, in particular a shell or part of a shell of a hard-shell case or trolley.

In an embodiment, the part of a luggage system comprises a fiber-reinforced material, wherein the fiber-reinforced material comprises a natural fiber material and a matrix material. The natural fiber material comprises at least one set of unidirectional fibers which are embedded in and/or impregnated with the matrix material.

Throughout most of this document, reference will simply be made to a “part of the luggage system” (or even shorter “luggage part”) for simplicity and conciseness, but the option of an entire luggage system like a complete hard-shell case or a complete trolley is always also implied, unless stated otherwise.

Moreover, besides a shell or part of a shell of a hard-shell case or trolley already mentioned, the disclosed fiber-reinforced material may also be applied to other kinds of luggage in which a fiber-reinforced material can be beneficially used, for example, as a reinforcement in certain areas of a bag or travel case otherwise made from a different material, e.g., at the edges or corners of the bag or case, or in the areas where wheels are attached.

In the context of this document, a natural fiber material, also sometimes called an organic fiber material, is a fiber material originating from a plant or other object of nature, in contrast to the synthetic or chemistry-based materials mentioned in the beginning and conventionally used in the art. Specific examples of such materials will be discussed below.

A set of unidirectional fibers is a set of fibers that are arranged (e.g., by intentional arrangement during manufacture) along a certain preferred direction, in contrast to fibers that are randomly or chaotically arranged, either by themselves or after having been processed into such an arrangement, e.g., by needling or gigging. Of course, in an actual product such unidirectional fibers will generally also not all be arranged perfectly parallel to said preferred direction, in the strict mathematical sense of the word “parallel”. A certain deviation that is, for example, unavoidable due to the manufacturing process and/or due to the natural irregularities in the shape of the fibers is allowed for, but a discernable “directivity” is provided to the arrangement of the fibers. The understanding of the term “unidirectional” as it is used in the context of this document can therefore be in line with the natural understanding the person skilled in the pertinent art will have of the term.

Besides the set or sets of unidirectional natural fibers, the natural fiber material may also comprise additional natural fibers in any sort of arrangement, but in a preferred option the natural fiber material is completely comprised of the one or more sets of unidirectional natural fibers.

The unidirectional fibers can be partially or fully embedded within the matrix material (suitable matrix materials and their respective properties will be discussed in the following), and/or they can be partially or fully impregnated with the matrix material. Being embedded within the matrix material can be understood in the sense that the fibers are suspended or “float” within a bed of matrix material, i.e., the fibers may be interspersed by the matrix material in the spaces between the individual fibers. Being impregnated with the matrix material can be understood in the sense that the matrix material is “soaked up” by the fibers, e.g., such that the fibers become “tacky” and stick to one another without a noticeable amount of matrix material being present between the individual fibers. Of course, graduations between the two options are also possible, i.e., the fibers may both be (partially) embedded within the material matrix and be (partially) impregnated with the matrix material.

Besides the natural fiber material comprising the at least one set of unidirectional fibers embedded in and/or impregnated with the matrix material, the fiber-reinforced material may also include additional materials or components, for example a (non-organic) textile fabric to provide further reinforcement in certain places that are subject to particularly high loads and forces. In a preferable scenario, however, the fiber-reinforced material does not contain any fibrous material besides the natural fiber material or natural fiber materials.

The part of a luggage system may be exclusively made from the fiber-reinforced material. However, the part may also include further components that are made of, or comprise, a different material or materials. For example, the part of a luggage system may be a (front and/or back) shell of a hard-shell case or travel- or cabin trolley which is generally made from a front shell and a back shell, and the shell main body may be made from the disclosed fiber-reinforced material. In addition, the shell may, for example, include a hinge-system, a zipper or closure-system, a handle bar or grip-structure, one or more wheels, and so forth, which may or may not comprise or be comprised of the disclosed fiber-reinforced material.

The natural or organic fiber materials that may be used in the context of the present invention (some examples of which will be discussed in more detail below) may require nearly no herbicides and pesticides, very little water to grow and very little energy to harvest and process, often with little or no harmful chemicals involved. Moreover, particularly when combined with a matrix material that is made of or comprises a bio-based and biodegradable compound, it may be possible that extracting the fibers from the matrix material at the end of life of the luggage system could be achieved through common composting methods which rely on water, ambient temperature, pressure and UV light to degrade, and thus be either be recycled or act as further soil nutrition.

Moreover, in non-directional composite materials (e.g., fiber-reinforced materials having randomly arranged fibers), as the reinforcing fibers have no specific orientation, energy upon impact is not distributed evenly through the material and thus should a failure occur any fracture in the material can propagate in any and multiple directions. This is particularly dangerous for luggage systems like trolleys, because there are generally no designated impact-absorption zones (in other words, an impact may occur on any part of the luggage and from any direction) and there is hence a high risk of damage or even destruction beyond the point of potential repair of the trolley if such non-oriented composite materials are used. Also, in such non-oriented materials, adding mass to certain regions (i.e., additional layers in the corners of the trolley) is almost always the method used to increase the strength of the material, which is at odds with the principles of sustainability and the ever increased restrictions on weight limits of luggage.

In contrast, the set of unidirectional fibers used by the present invention will displace the impact energy in a more predictable and controllable manner, as each fiber will channel energy in a specific orientation and in the path of least resistance. Besides the option of orienting the fibers such that energy is more efficiently dispersed from regions where impact can at least be considered more likely to occur (e.g., at the edges or corners), the unidirectional fibers can hence also limit the amount of damage should a fracture occur after all, for example, by directing the fracture in a less critical direction with regard to the overall stability of the luggage/trolley. Compared to the use of randomly arranged fibers, the unidirectional fibers used in the disclosed material can therefore provide a “stability frame” to the material, which increases its overall stability and lifetime.

Another benefit of using the natural fibers in a unidirectional arrangement is that natural fibers are often very strong in longitudinal direction, but may fray or split or otherwise disintegrate if pulled on or loaded in a sideward direction (in contrast to synthetic fibers where this problem may not exist or only to a smaller degree). Also in this regard, using natural fibers in a suitably chosen unidirectional arrangement (e.g., such that the fibers are predominantly loaded in their longitudinal direction) can therefore help to increase the lifetime of the product compared to using natural fibers in a completely random arrangement, where fraying and splitting of the individual fibers may occur to a larger degree.

It is mentioned in this regard that the part of a luggage system may also comprise two or more regions in which fiber-reinforced materials with a differently oriented set or sets of unidirectional natural fibers are used, to take into account the specific geometry of these regions and/or the kind of impact that is likely to occur in these regions, for example. The material composition of the natural fibers and/or the matrix material, or other physical- and mechanical properties thereof, may also change between such regions.

To summarize, the use of the disclosed fiber-reinforced material comprising the natural fiber material with the at least one set of unidirectional fibers embedded in and/or impregnated with the matrix material combines the beneficial mechanical properties of such an oriented material, particularly for the construction of luggage systems like hard-shell cases or trolleys, with the environmental friendliness of natural base materials.

Further options and modification pertaining to the first aspect of the present invention will now be indicated and discussed, and these further options and modifications may also be combined with one another to obtain the desired material- and performance characteristics of the part of the luggage system, even if not every single possible permutation among the disclosed options is explicitly spelled out in the following. Individual features of sub-features may also be omitted if deemed not necessary to obtain the desired goal.

For example, the natural fiber material may comprise n sets of unidirectional (natural) fibers which are embedded in and/or impregnated with the matrix material, wherein n is an integer number greater than 1, and wherein the n sets of unidirectional fibers are mutually non-parallel.

In other words, the natural fibers may provide a multi-axial material, wherein n is the number of axes. By increasing the number n of axes, the isotropy of the material properties can be increased, possibly at the cost of higher manufacturing expenses and complexity, such that there will generally be a compromise between stability and isotropy on the one hand, and manufacturing costs and complexity but also weight of the product on the other hand.

Also in the context of more than one set of unidirectional fibers, it is possible that the part of the luggage system comprises several regions (i.e., two or more) in which different embodiments of the disclosed material are used. To give one specific example, a shell of a hard-shell case or trolley may comprise on its main face a fiber-reinforced material comprising a natural fiber material with two sets (i.e., n=2) of unidirectional (natural) fibers which are embedded in and/or impregnated with the matrix material. At the edges and/or corners and/or where the wheels are attached, the shell may comprise a fiber-reinforced material comprising a natural fiber material with three or more sets (i.e., n≥3) of unidirectional (natural) fibers which are embedded in and/or impregnated with the matrix material, to provide a high degree of stability to these specific regions. The material composition and/or mechanical properties of the natural fibers and/or the matrix material may also change between the different regions, to further control the properties of the luggage part.

In particular, each set of unidirectional fibers may comprise a plurality of fiber bundles and/or fibrous yarns that are arranged along a respective axis.

In other words, the fibers can be prearranged or spun into bundles or yarns that are then oriented and incorporated into the fiber-reinforced material to from the part of the luggage. This can not only facilitate and simplify manufacture, it may also increase the “directivity” of the fiber-reinforced material and hence lend particular strength to the directions defined by the material axis or axes.

As mentioned, there may be two sets of unidirectional (natural) fibers used, i.e., n=2, meaning that the natural fiber material is provided as a bi-axial fabric or material.

A bi-axial material is the simplest case of a multi-axial material beyond the case of having only one set of unidirectional fibers that are oriented along one single axis. It may therefore be relatively easily manufactured but already provide better isotropy and general stability than a single-axis material. In particular in view of the fact that natural fibers may be more stable in longitudinal direction (i.e., along the extension of the fiber) than in lateral/sideward direction, already adding one more axis to the material may significantly increase the stability and longevity of the part of the luggage system. A bi-axial material therefore provides for a lightweight yet sufficiently stable and easily manufactured fiber-reinforced material for luggage construction on the basis of natural or organic fibers.

The two axes of the bi-axial fabric may intersect at an oblique angle (i.e., an angle not equal to 90°).

Generally, an intersection-angle of the two axes equal to 90° is of course also possible. However, an oblique intersection angle (i.e., 90°) may further provide for the opportunity to combine a high general stability of the luggage part, due to the usage of more than one axis, with the provision of a further degree of “directivity” or anisotropy. Due to the fact that the two axes do not intersect at 90°, there will be an acute angle (i.e., an angle <90°) formed between them, as well as a complementary obtuse angle (i.e., an angle >90°). For example, the direction defined by the angle dissector of the acute angle will be “closer” to the two axes than the angle dissector of the obtuse angle, such that along the angle dissector of the acute angle a larger stiffness/stability can be obtained compared to the perpendicular direction, i.e. along the direction angle dissector of the obtuse angle. The skilled person recognizes how this concept can be used to influence the physical and mechanical properties of the luggage part not only along the two material axes themselves, but also in the angle segments between them.

Another option is that there are three sets of unidirectional (natural) fibers, i.e., n=3, meaning that the natural fiber material is provided as a tri-axial fabric or material.

One benefit of using three axes (or an even larger number of axes, e.g., n=4, 5, 6, . . . , although further increasing the number of axes beyond n=3 may become too prohibitive from a constructional and manufacturing point of view) is that any impact energy leading to an initial fracture of the luggage part in some position is quickly met with barriers to that energy at the nearest intersection point or points of the different sets of fibers, and thus redirected into three directions. This redirection of energy will continue and divide again until it exists the system or dissipates within the material. In this manner, large fractures can be avoided, which facilitates repair instead of discarding. In addition, the overall stability and isotropy of the material is increased compared to using one or two axes only.

Also in this case, at least two of the axes of the tri-axial fabric may intersect at an angle different from 60°.

In other words, also for more than two axes, the axes (or at least some of them) may intersect at an “irregular” angle, wherein the “regular” angle for n axes to intersect may be considered to be 360° divided by n (wherein the intersection angle may be taken as the acute angle formed by two intersecting oblique axes, not the complementary obtuse angle).

The fibers contained in the natural fiber material may be continuous.

Continuous fibers, e.g., fibers that have not been torn or cut or otherwise shortened during or after being extracted from their natural source, maintain a very high degree of (tear-) strength in their longitudinal direction (along the extension of the fiber), which translates into a corresponding high stability of the luggage part in which they are used. Also, by using continuous fibers the manufacturing process can be facilitated or even made possible in the first place, in particular if the natural fibers are processed to form a woven fabric. However, also for a layered fabric the use of continuous fibers can be beneficial and increase the general tear strength of the finished product along the fiber direction or directions. Irrespective of the structure of the natural fiber material (woven or layered), the use of continuous fibers can increase the luggage part's resistance against uncontrolled damage propagation by channeling impact forces along the extension of the fibers.

The addition of discontinuous and/or particulate (natural and/or synthetic) fibers to the fiber-reinforced material is generally also possible, of course. However, the predominant or exclusive use 0f continuous natural fibers is beneficial in the sense that it can enhance the “directivity” of the fiber-reinforced material and limit uncontrollable damage propagation which has already been mentioned a number of times above, and from a sustainability point of perspective.

The natural fiber material can be provided as a layered fabric.

Providing the natural fiber material as a layered structure may reduce the manufacturing effort compared, for example, to utilizing a woven structure as discussed below, potentially at the cost of a slightly lower stability of the material. For example, manufacture could be performed via wet layup by layering one or more sheets or layers of oriented fibrous material within a bed of liquid resin, which will form the matrix material after curing, and then compression molding this pre-form into the desired shape, for example under the influence of pressure and by curing the resin by heat, ultraviolet light or a rapid change in humidity pending the required resin setting method. Or manufacture could proceed via impregnated sheets or layers of fibrous material that are suspended in or on an epoxy resin, a thermoplastic resin or a film, and then be thermoformed into the desired shape.

Each layer can further comprise several plies of parallel-oriented, unidirectional fibers. Or only some of the layer comprise several plies of parallel-oriented, unidirectional fibers, wherein the number of plies per layer may further vary between the individual layers.

Stacking up the layers by several plies of parallel-oriented, unidirectional fibers can on the one hand lead to an easier manufacture, and on the other hand allow exerting a more fine-tuned control on the thickness, density, tear-strength, and so forth, of each individual layer, in particular if the number of plies is individually controlled for each layer.

It is also possible that the natural fiber material is provided as a woven fabric, particularly a fabric woven from the above-mentioned fiber bundles and/or fibrous yarns.

Providing the natural fiber material as a woven fabric will generally require at least two sets of unidirectional fibers that are non-parallel to each other, i.e., at least a bi-axial fabric, contrary to layering which can also be used with only one set of unidirectional natural fibers. Therefore, while weaving may be more expensive and complex from a manufacturing point of view compared to layering, it may also lead to an improved stability and longevity of the luggage part, due to the fact that the sets of unidirectional fibers are interwoven and hence locked onto each other by the spatial arrangement created during the weaving process, which prevents the different sets of fibers from being easily separated/delaminated.

The natural fiber material of the present invention may comprise fibers of one or more of the following materials or plant parts: leaf fibers, bast fibers, or stalk fibers.

To name a number of specific examples of these different categories, leaf fibers that may be used with the present invention include fibers of abaca, piña and/or palm, bast fibers that may be used include fibers of hemp, flax, ramie, kenaf and/or jute, and stalk fibers that may be used include fibers of bamboo and/or straw.

Even more specifically, some examples of natural fiber materials that may be used within the present invention include: a tri-axial natural fiber material using flax and/or bamboo fibers, or a bi-axial natural fiber material using basalt and/or bamboo fibers. These materials can be beneficially used with the present invention as they provide a good combination of commercial availability, structural and mechanical stability, and a small environmental footprint.

A material composition of the natural fiber material can further vary within a given set of unidirectional fibers and/or between at least two sets of unidirectional fibers. Alternatively, or additionally, one or more physical properties, in particular a gauge of the fibers and/or a linear mass density of the fibers, can vary within a given set of unidirectional fibers and/or between at least two sets of unidirectional fibers.

For example, flax fiber can be a split bast and be split into increasingly smaller widths or gauges, or it can used without dividing the bast at all. The use of flax can be beneficial from the point of view that flax is easily commercially available.

The same can be said for bamboo, which is a stalk fiber, and which has an even greater capacity in maximum fiber size. The use of bamboo may particularly be considered as a fiber material for localized reinforcement, due to its higher density, but also as a primary fiber for larger luggage parts or entire cases that require more impact strength.

These options hence allow to further influence the physical and mechanical properties of the luggage part locally and in a controlled manner, beyond the orientation and number of axes (i.e., the number of sets of unidirectional fibers) that are used for natural fiber material of the fiber-reinforced material of the present invention.

Preferably, the matrix material is biodegradable and/or comprises recycled material. Particularly preferred is a biodegradable material which provides high impact capabilities to the finished luggage part.

One possibility in this regard is the use of a thermoplastic film of polylactic acid (PLA) as matrix material or part thereof.

As mentioned above, using a biodegradable matrix material (for example, a matrix material based on or consisting of the just-mentioned PLA) in combination with a reinforcement structure based on a natural fiber material may allow the entire luggage part, or at least large portions thereof, to be biodegradable as well, and hence very appealing form a sustainability point of view. Alternatively, even though less preferred from a point of view of sustainability, recycled material may be used (which is generally still better than using brand-new materials), which has the benefit of having a larger class of materials to choose from, because biodegradable matrix materials/plastics are not yet developed to the same degree and available in the same number and diversity as recyclable plastics are.

Bio-based polyethylene (PE), polypropylene (PP), polyamide-6 (PA6), polyamide-11 (PA11), polyamide-12 (PA12) and/or polycarbonate (PC) may also be used as matrix material or part thereof, even though these materials are not (fully) biodegradable, but may at least be more environmentally friendly when it comes to their sourcing and production (compared to plastics based in crude oil, for example).

Generally, however, the matrix material used in an inventive part of a luggage system may comprise one or more of the following materials: an amorphic, crystalline or semicrystalline thermoset resin; an amorphic, crystalline or semicrystalline thermoplastic resin; or a film of any of the beforementioned thermoset of thermoplastic materials or combinations thereof.

All of these materials have their benefits and drawbacks, which are generally known to the person skilled in the art, and may therefore be used and selected depending on the desired properties of the luggage part they are used in. For example, thermoset resins may be less preferred from a manufacturing point of view, because they require relatively long cycle times for curing, but may provide beneficial properties in the finished component like high impact capabilities, for example.

Irrespective of the base material(s) the natural fibers are of and of the chemical composition of the matrix material, the inventive part of a luggage system, can be free from aluminum.

Aluminum has long been used—and still is—in large amounts in all kinds of luggage on the market, in the form of entire luggage shells or as reinforcement and protection elements at the corners, for handle bar systems, and so on, while from a sustainability point of view it is notoriously undesirable. The present invention provides an alternative to using this problematic material by providing the discussed fiber-reinforced material based on the use of a natural fiber material that can still provide a comparable stability and longevity to the products it is used in, but at a much smaller ecological footprint.

A second aspect of the invention relates to a method for the manufacture of a luggage system or part of a luggage system according to the first aspect.

The skilled person understands that the embodiments, features and options discussed above with regard to a part of a luggage system according to the first aspect of the present invention generally translate to corresponding features regarding the manufacture of such a part. The embodiments, features and options discussed above thus also apply (as far as technically and physically applicable, of course) to the second aspect of the present invention discussed now, namely the manufacture of such a part, and are therefore not all repeated again. Instead, only a few specific embodiments and options as well as advantages of the second aspect are mentioned in some more detail in the following, and reference is made to the detailed explanations given above in the context of the first aspect of the invention in all other regards.

In an embodiment, the manufacturing method comprises the steps of: providing a preform; heating the pre-form and transferring the pre-form to a mold having dimensions that correspond to the intended shape of the part; closing the mold, preferably under the application of pressure, such that the pre-form adopts the intended shape of the part; curing the preform or allowing it to cure, preferably under the application of: heat, UV light and/or ultrasonic waves, and/or under a change in: temperature and/or humidity; and opening the mold and demolding the part.

Preferably, the curing occurs within the mold, and preferably while the mold pressure is at least partially or fully maintained. Conceivably, however, the sequence of method steps may also be changed and the mold may be opened and the part be removed before and/or during the curing process. Or the mold pressure may be significantly reduced during curing. Or the mold be opened but the part still be left inside the mold for curing.

Moreover, the sub-step of heating the pre-form before transferring it to the mold may also be omitted, for example, if the pre-form does not need to be heated to be made or be kept malleable (for example, if the matrix material is still “wet”), and the heating may also, at least partially, be performed within the mold and/or during closing of the mold.

The part thus manufactured may be a shell or part of a shell of a hard-case shell or trolley, as already indicated a number of time, but it may also be the main body of part of the main body of a different kind of luggage. It may also be or comprise part of a wheel assembly, a handle bar system, and interior structure, and so forth of a piece of luggage and the dimensions and geometry of the mold will correspond to the nature of the part in a manner the skilled person easily perceives.

The curing process will depend on the composition of the matrix material that is used in a given process and will not be further discussed here.

For the case that the natural fiber material is intended as a layered structure, providing the pre-form may comprise the steps of providing one or more plies of unidirectional natural fibers, and layering up the plies to form a stack of one or more layers of unidirectional fibers, the unidirectional fibers of each layer being arranged along a respective axis, wherein uncured matrix material is applied to the plies of unidirectional fibers and/or to the layered stack and is allowed to be at least partially absorbed by the natural fibers to form the pre-form.

That is, the uncured matrix material can be provided before, during or after the layering of the stack. If provided during the layering, it may be continuously added to the growing stack, or after a predefined number of plies has been added or after some other pre-defined time interval, for example.

It is once again mentioned that the layers of the stack may all have the same number of plies, or the number of plies (i.e., sub-layers) may vary between two of more or the layers.

The plies may already be pre-oriented prior to being added to the stack, for example when being stored in a suitable storage container or the like, or they may be brought into the correct orientation directly when being applied to the stack.

Providing the pre-form may further comprise fusing the locations where fibers of the different plies or layers cross or overlap within the stack, for example under the application of: pressure, heat, UV light and/or ultrasonic waves.

This may not only facilitate handling of the pre-form and the subsequent steps of the manufacturing process, it may also increase the overall stability and strength of the manufactured part.

For the case that the natural fiber material is intended as a woven structure, providing the pre-form may comprise the steps of providing at least one natural fiber material in the form of a woven multi-axial fabric, providing at least one uncured matrix material in the form of a ribbon, sheet or film, and laminating the natural fiber material with the uncured matrix material, preferably under the application of: heat and/or pressure, and allowing the natural fiber material to a least partially absorb the uncured matrix material to form the pre-form.

In either case (i.e., for a layered structure or a woven structure), the invention allows for an ecologically friendly manufacturing process, basically from agriculture to final processing, for example by one of the following exemplary processes:

(a) Bast fibers are harvested either as a primary or secondary agriculture product. If secondary, the primary product (e.g., linseed, bananas, cannabis) is separated from the harvest stock. Pending plant type and climate, unwanted stock material is then removed by a number of different processes and is then dried. Depending on the desired stock fiber gauge, stocks may be split into smaller dimensions. The fibers are then prepared as continuous fibers with single or multiple species blends. The continuous bast fibers are woven into a fabric, which may or may not mix with other fiber types (e.g. deriving from minerals, wood or bamboo) in the weaving process into the desired blend, orientations and dimensions.

A thermoplastic resin or resins, which may be based in crude oil, but preferably in organic matter, and which may or may not be further reinforced with short or long fibers of any origin or otherwise modified to withstand high impact forces, is dried to a desired degree/percentage of moisture, and then extruded through a die to a desired geometry and dimension, commonly as a ribbon or a continuous sheet.

The thermoplastic sheet or film is then laminated to the woven fabric, predominately with heat and pressure until the fibers are impregnated with the thermoplastic resin, and then partially cooled and cut into the desired dimension.

This pre-form is then used in a thermoforming process by which a three-dimensional mold and the pre-form meet, and the material is formed into the desired part with heat and pressure.

(b) Alternatively, the pre-form could be layered with one or more fiber layers and then liquid epoxy could be applied through all layers of the pre-form to impregnate the fibers and act as a bonding agent that would behave similar to a thermoplastic resin. The wet layup matrix of the fiber layers and epoxy could be applied directly onto a three-dimensional mold, or be prepared in a flat condition and then moved onto a three-dimensional mold. The three-dimensional mold would usually have at least two parts to its cavity, commonly a male one and a female one defining a molding cavity between them. Heat and pressure would then be applied to the parts of the cavity to thermoset the epoxy in the desired shape.

Additionally, it would also be conceivable to impregnate the fibers with a resin/epoxy and then orient the fibers (e.g., similar to that of a weaving process), and then fuse all locations where the impregnated fibers overlap via heat and pressure, or via pressure and frequency similar to ultrasonic welding. This pre-form could then be thermoformed in either a wet or a dry process.

(c) After either molding process, the excess materials could be cut away, and further holes could be cut into the formed part to mount any number of other components and fasteners both internally and externally in the final assembly.

A third aspect of the invention relates to a method for the repair of a luggage system or part of a luggage system according to the first aspect of the invention that has been damaged.

Also for this third aspect, the skilled person understands that the embodiments, features and options discussed above with regard to a part of a luggage system according to the first aspect of the present invention and/or a manufacturing method according to the second aspect of the present invention generally translate to corresponding features regarding the repair of such a part. Therefore, only a few specific embodiments and options as well as advantages of the third aspect of the invention are briefly mentioned below, and reference is made to the detailed explanations given above in the context of the first and/or second aspect of the invention in all other regards.

In an embodiment, the method for repair comprises the steps of: adding uncured matrix material to the damaged area of the part; allowing the natural fiber material in the damaged area to absorb the added uncured matrix material at least partially; applying pressure to the damaged area (e.g., to further facilitate absorption of the uncured matrix material and/or to re-shape the damaged area into the desired shape); and curing the added uncured matrix material or allowing it to cure, preferably under the application of: heat, UV light and/or ultrasonic waves, and/or under a change in: temperature and/or humidity.

In another embodiment, the method for repair comprises the steps of: adding uncured matrix material to the damaged area of the part; allowing the natural fiber material in the damaged area to absorb the added uncured matrix material at least partially; and curing the added uncured matrix material or allowing it to cure, preferably under the application of: pressure, heat, UV light and/or ultrasonic waves, and/or under a change in: temperature and/or humidity.

The two embodiments just mentioned basically differ in the way pressure is used during the process: In the first embodiment, the damaged area is subjected to pressure prior to the curing process, while in the second embodiment pressure may or may not be applied during the curing process. Which option is more suitable, and whether the application of pressure is necessary at all, may dependent on the size and shape of the part and of the damaged area, as well as the composition of the matrix material and the nature of the curing process.

In conventional fiber-reinforced materials based in mineral or synthetic materials, the fiber itself is typically relatively hydrophobic and cannot absorb resin into the fiber at nearly the capacity of a natural or organic fiber with its cellular structure. Also, mineral fibers are comparatively brittle. In the event that a piece of luggage containing such a material fractures, it is uncommon for the part to be able to be repaired, as patching such an area would require material to be added on the top and bottom of the affected area with the original substrate residing between. To add strength, holes must furthermore be added to the composite which have a very high risk of becoming a new weak point that will not withstand a repeated impact.

The use of natural fibers as prescribed by the present invention overcomes this problem, because natural fibers are typically hydroscopic, and can thus absorb more resin in the areas of fracture in the repair/patching process than fibers of mineral or synthetic materials. This makes it possible to strengthen the part in repair and not weaken it. Moreover, the repair process can potentially occur many times and if the repair process is thought to be exhausted or is not economically feasible, the luggage part can be completely or at least predominantly compostable or biodegradable, as already discussed above.

In this context, components such as fabrics, handles and wheels comprising the disclosed fiber-reinforced material with the natural fiber material could, for example, be repurposed (e.g., after having been worn out) for repairs of trolley shells made from such material.

### BRIEF DESCRIPTION OF THE FIGURES

Possible embodiments of the present invention are described in more detail, with reference to the following figures:

FIGS. 1a-c: Examples of a fiber-reinforced material comprising a natural fiber material and a matrix material that may be used in an inventive part of a luggage system;

FIG. 2: Example of an inventive method for the manufacture of an inventive part of a luggage system;

FIG. 3: Further example of an inventive method for the manufacture of an inventive part of a luggage system;

FIG. 4: Example of an inventive part of a luggage system with a bi-axial, woven natural fiber material; and

FIGS. 5a-h: Example of an inventive luggage system in the form of a travel-or cabin trolley.

### DETAILED DESCRIPTION OF POSSIBLE EMBODIMENTS

Possible embodiments of the different aspects of the present invention are described below, predominately with respect to travel- or cabin trolleys. It is, however, emphasized once again that the different aspects of the present invention may also be practiced in different kinds of luggage systems and are not limited to the specific embodiments set forth below.

Reference is further made to the fact that in the following only individual embodiments of the invention can be described in more detail. The skilled person will understand, however, that the features, options and possible modifications described with reference to these specific embodiments may also be further modified and/or combined with one another in a different manner or in different sub-combinations, without departing from the scope of the present invention. Individual features or sub-features may also be omitted, if they are deemed dispensable to obtain the desired result. In order to avoid redundancies, reference is therefore made to the explanations in the preceding sections, which also apply to the following detailed description.

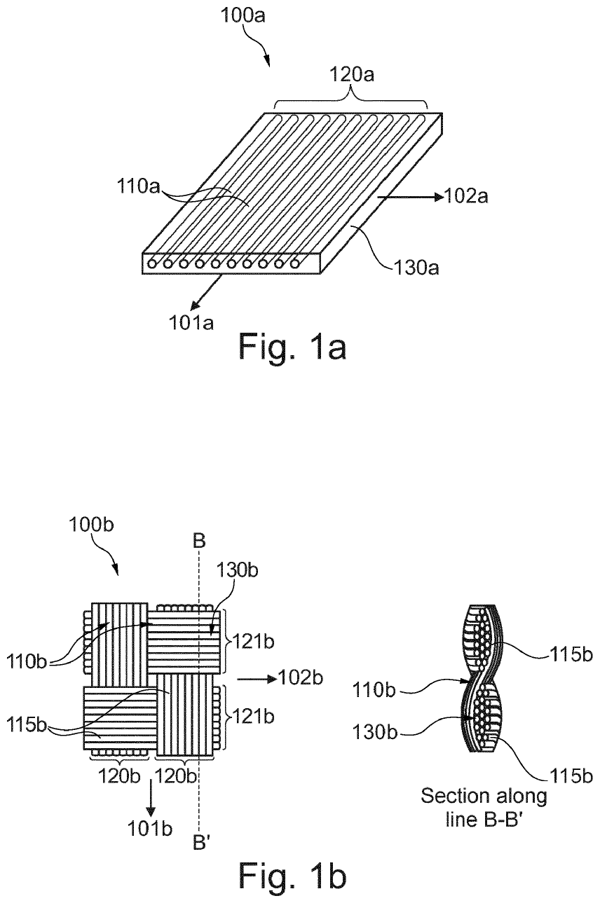

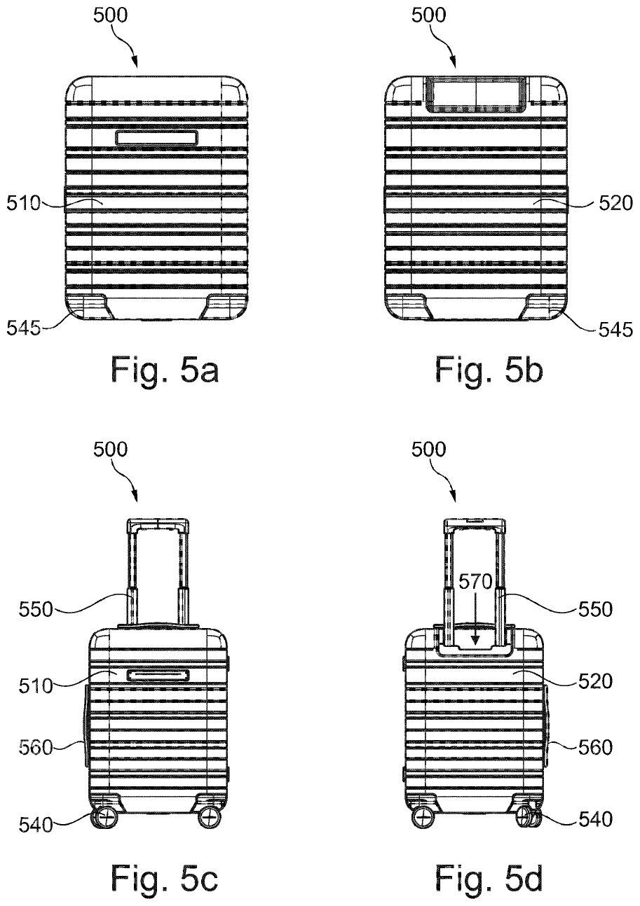

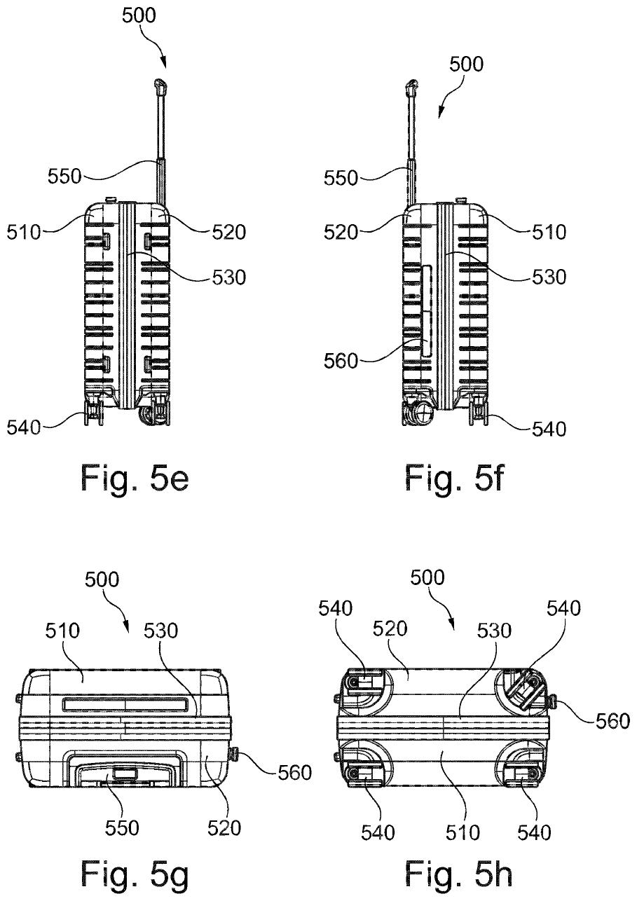

FIGS. 1a-c show examples of fiber-reinforced materials 100a, 100b and 100c comprising a natural fiber material with at least one set of unidirectional fibers embedded in and/or impregnated with a matrix material, which may be used in a part of a luggage system according to the present invention (examples of such parts are shown in FIG. 4 and in FIGS. 5a-h).

FIG. 1a shows a fiber-reinforced material 100a comprising a natural fiber material that comprises continuous natural fibers 110a. Discontinuous and/or particulate fibers may also be added to the fiber-reinforced material 100a, but this is not shown and further discussed here.

The continuous natural fibers 110a can be provided as a plurality of fiber bundles/fibrous yarns. The natural fibers 110a form a set 120a of unidirectional fibers arranged along the longitudinal direction 101a in FIG. 1a. Also indicated in FIG. 1a is the transvers direction 102a, which is perpendicular to the longitudinal direction 101a. In the part of a luggage system made of or comprising the material 100a, the longitudinal direction 101a may be arranged, for example, along the direction of greatest spatial extension of the part, but this need not necessarily be the case. In other words, the designation as “longitudinal” and “transverse” directions are predominantly used to facilitate the understanding of the following explanations and for definiteness, but they do not necessarily mandate a specific arrangement of the material 100a within the part of a luggage system in which it is used. For example, the longitudinal direction 101a may also be arranged obliquely or diagonally with respect to the edges of a shell of a hard-shell case or trolley in which the material 100a is used (e.g., in one of the shells 510, 520 of the trolley 500 discussed further below).

The fibers 110a of the set 120a are embedded within a matrix material 130a. The fibers 110a may also have “soaked up” the matrix material 130a and hence be impregnated with the matrix material 130a. Moreover, while in the situation shown in FIG. 1a the fibers 110a are completely embedded in the matrix material 130a, i.e., fully contained therein (apart from may be their beginnings and ends), this need not necessarily be the case in all situations. In other words, the fibers 110a can also be only partially embedded within the matrix material 130a, or reside “on top” of the matrix material 130a, or only contain matrix material 130a within their inside, i.e., only be impregnated with the matrix material 130a but not be surrounded by or embedded in any matrix material 130a on their outsides. These statements also apply to fiber-reinforced materials containing more than one set (i.e., n sets with n>1) of unidirectional fibers, e.g., the materials 100b and 100c discussed in the following, even if this is not explicitly repeated again every single time.

The fibers 110a of the natural fiber material may, for example, comprise one or more of the following materials: leaf fibers, bast fibers, or stalk fibers.

For example, the use of flax, which is a bast fiber, for the fibers 110a (or for any of the natural fibers discussed herein) can be beneficial from the point of view that flax is easily commercially available. The use of bamboo, which is a stalk fiber, may also be considered, particularly as a fiber material for localized reinforcement, due to its higher density, but also as a primary fiber for larger luggage parts or entire cases that require more impact strength.

The matrix material 130a may comprise or be comprised of one or more of the following materials: an amorphic, crystalline or semicrystalline thermoset resin; an amorphic, crystalline or semicrystalline thermoplastic resin; or a film of any of the beforementioned thermoset of thermoplastic materials or combinations thereof. Preferably, the matrix material 130a is biodegradable and/or comprises recycled material.

One specific option is the use of PLA as the matrix material 130a, or at least base the matrix material 130a thereon, due to its known biodegradability. Generally, biodegradable and impact-resistant, bio-based thermoplastics or resins are well suited to the present invention.

As alternatives, partially or completely bio-based PE, PP, PA6, PA11, PA12 and PC materials can also be considered, even though these materials may not be (fully) biodegradable, but still be more environmentally friendly than conventional plastics based on crude oil, for example.

FIG. 1b shows, on the left-hand side, another fiber-reinforced material 100b. On the right-hand side of FIG. 1b, a cross-section along the line B-B′ through the material 100b is shown.

The material 100b comprises a natural fiber material that comprises continuous natural fibers 110b. Discontinuous and/or particulate fibers may again be added to the fiber-reinforced material 100b, but this is again not shown or further discussed here.

The continuous natural fibers 110b are provided in the form of fibrous yarns 115b which are woven into a bi-axial fabric and are arranged either along the longitudinal axis (or direction) 101b, or along the transverse axis (or direction) 102b. Again, this nomenclature is predominantly used for definiteness and not necessarily limitation, see the corresponding explanations about the directions 101a and 102a with regard to FIG. 1a above. The longitudinal direction 101b could, for example, be the warp direction and the transvers direction 102b could be the weft direction, or vice versa, in a weaving process used to create the woven fabric from the fibrous yarns 115b.

In the material 100b shown in FIG. 1b, there are thus two sets 120b and 121b of unidirectional fibers, the set 120b being formed of the fibrous yarns 115b woven along the longitudinal direction 101b, and the set 121b being formed of the fibrous yarns 115b woven along the transverse direction 102b.

In the material 100b shown in FIG. 1b, the yarns of the two sets 120b and 121b and their respective axes intersect at an angle of (approximately) 90°. In other embodiments, however, the intersection angle can be different from 90°, i.e. the fibrous yarns 115b and their respective axes can also be arranged at an oblique angle 90°) with respect to each other. The advantages of employing such a non-perpendicular arrangement have already discussed in section no. 3 above, to which reference is therefore made for conciseness.

The fibers 110b in the material 100b may have “soaked up” a matrix material 130b and may hence be impregnated with the matrix material 130b. The fibers 110b may also be at least partially embedded in or surrounded by matrix material 130b. However, the fact that the fibers 110b are woven into a bi-axial fabric in the material 100b shown in FIG. 1b already provides structural stability to their arrangement, such that the fibers 110b in this case need not necessarily be (partially) embedded in the matrix material 130b to fix their arrangement and to obtain the desired overall stability of the material 100b, but impregnating the fibers 110b with the matrix material 130b may already be sufficient for that purpose.

A material composition of the natural fibers 110b and/or the fibrous yarns 115b can vary not only between the two sets 120b and 121b, but also within a given one of the sets 120b, 121b of unidirectional fibers. Alternatively, or additionally, one or more physical properties, like a gauge of the fibers 110b and/or a linear mass density of the fibers 110b can vary within a given one of the two sets 120b, 121b of unidirectional fibers and/or between the two sets 120b and 121b of unidirectional fibers. This allows to locally fine-tune the physical and mechanical properties of the material 100b even further and beyond the “global” control exerted, for example, by the selection of the arrangement and/or weaving pattern used for the bi-axial fabric of the material 100b.

With regard to suitable material choices for the natural fibers 110b and/or the matrix material 130b, reference is made to the corresponding explanations above, for conciseness (see, e.g., the statements about the fibers 110a and the matrix material 130a made with regard to FIG. 1a).

FIG. 1c shows another fiber-reinforced material 100c comprising a natural fiber material that comprises continuous natural fibers 110c. Discontinuous and/or particulate fibers may also be added to the fiber-reinforced material 100c, but this again is not shown and further discussed here.

The continuous natural fibers 110c can be provided as a plurality of fiber bundles/fibrous yarns 115c. The natural fibers 110c form n sets of unidirectional fibers, wherein for the embodiment shown in FIG. 1c n=4, i.e., there are four sets 120c, 121c, 122c and 123c of unidirectional fibers here, each set being arranged along a corresponding axis or direction. The fibers of two of the four sets 120c, 121c, 122c, 123c of unidirectional yarns are mutually non-parallel, i.e. they intersect at an angle different from 0°. The fibers 110c are embedded in and/or impregnated with a matrix material 130c.

A modification (not shown) of the material 100c would have not four but three sets of unidirectional fibers 110c (i.e., n=3, a tri-axial fabric), wherein the fibers of two of the three sets of unidirectional yarns are mutually non-parallel, i.e. they intersect at an angle different from 0°. Preferably, at least two of the three sets would also intersect at an angle different from 60°, with the resultant technical advantages discussed in section no. 3 above, to which reference is therefore made in this regard.

In the material 100c, the natural fiber material is provided as a layered fabric, wherein eight layers 140c to 147c are shown in the embodiment of FIG. 1c. Each of the layers 140c, 141c, . . . , 147c further comprises several plies of parallel-oriented, unidirectional fibers 110c, which are numbered as ply no. 1 to ply no. 48 in FIG. 1c. In other words, in the embodiment of FIG. 1c, each of the layers 140c, 141c, . . . , 147c comprises six plies.

In the embodiment of FIG. 1c, each of the four sets 120c, 121c, 122c, 123c of unidirectional fibers includes two of the layers 140c, 141c, . . . , 147c:

The first set 120c comprises layers 140c and 147c with plies no. 1-6 and no. 43-48, respectively, in which the fibers are arranged at an angle of 0° with respect to the transvers direction (which is taken as the point of reference here without loss of generality).

The second set 121c comprises layers 141c and 146c with plies no. 7-12 and no. 37-42, respectively, in which the fibers are arranged at an angle of +45° with respect to the transvers direction.

The third set 122c comprises layers 142c and 145c with plies no. 13-18 and no. 31-36, respectively, in which the fibers are arranged at an angle of +90° with respect to the transvers direction.

The fourth set 123c comprises layers 143c and 144c with plies no. 19-24 and no. 25-30, respectively, in which the fibers are arranged at an angle of −45° with respect to the transvers direction.

Also here (i.e., also for the situation n>2), a material composition of the natural fibers 110c or fiber bundles/fibrous yarns 115c can vary between two (or more) of the sets 120c-123c, and also within a given one of the sets 120c-123c of unidirectional fibers (for example, between different layers or even different plies contained in one of the sets, or even within a given ply). Alternatively, or additionally, one or more physical properties, like a gauge of the fibers 110c and/or a linear mass density of the fibers 110c, can vary within a given one of the sets 120c-123c and/or between two (or more) of the sets 120c-123c of unidirectional fibers.

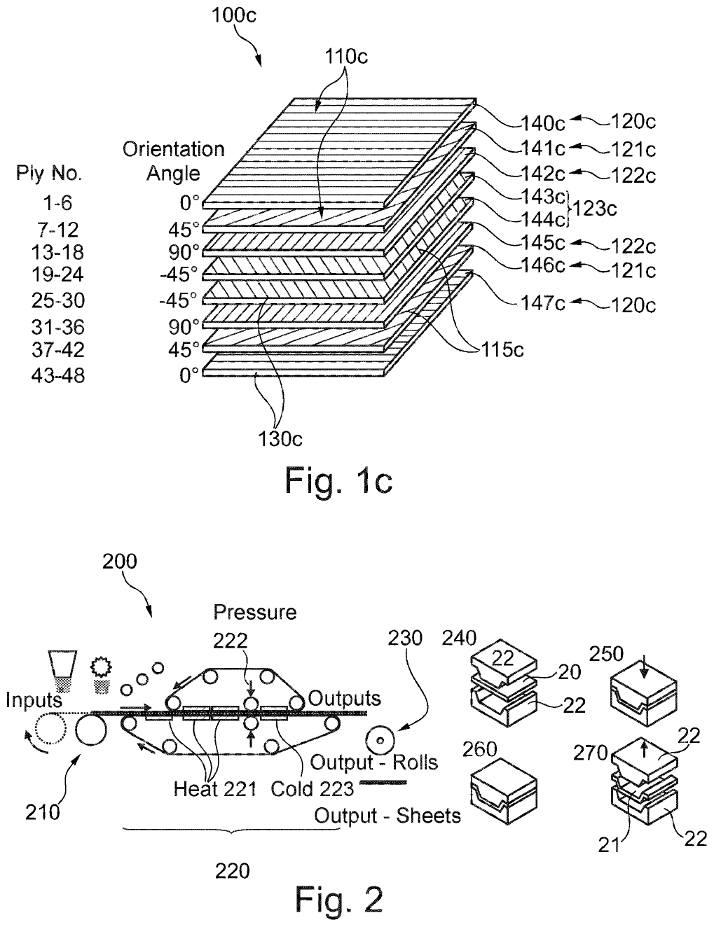

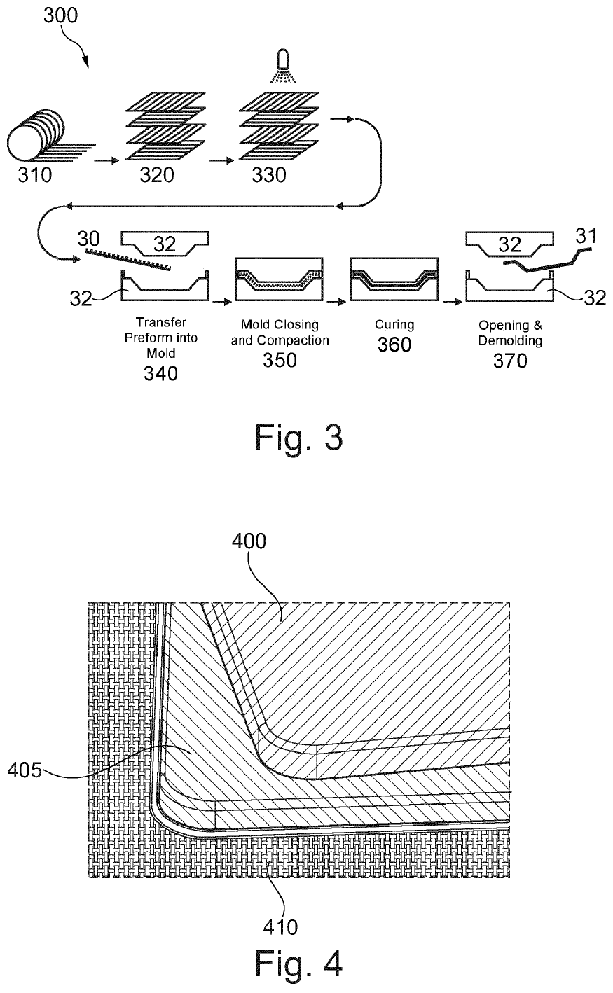

FIGS. 2 and 3 show schematic illustrations of examples of an inventive method 200, 300 for the manufacture of an inventive part of a luggage system (examples of such parts are shown in FIG. 4 and in FIGS. 5a-h).

The method 200 of FIG. 2 starts, generally indicated by reference numeral 210, by providing input materials to a production site for the preparation of a pre-form 20 for the manufacture of the luggage part 21. The step 210 of providing the input materials can, in particular, comprise providing at least one natural fiber material in the form of a woven multiaxial fabric as well as providing at least one uncured matrix material in the form of a ribbon, sheet or film.

Further materials and components that may be provided in step 210 include, for example: adhesives, like adhesive powders, adhesives films, web adhesives; chopped glass; textile materials for further reinforcement; foils material.

The method 200 further comprises the step of laminating the natural fiber material with the uncured matrix material and allowing the natural fiber material to a least partially absorb the uncured matrix material to form the pre-form 20, generally indicated by reference numeral 220. In the embodiment of the method 200 shown in FIG. 2, the lamination is performed under the application of heat (see reference numeral 221) and pressure (see reference numeral 222), and the laminated structure is subsequently cooled down (see reference numeral 223), to stabilize the pre-form 20.

The pre-form 20 may be stored in the form of rolls or sheets, as generally indicated at reference numeral 230.

After providing the pre-form 20 in this manner, the method 200 further comprises the (optional) step of heating the pre-form 20 (the heating may also occur, at least partially, within the mold 22 and/or during closing of the mold 22, or be omitted completely if not necessary to make or keep the pre-form 20 malleable) and the method 200 comprises the step of transferring the pre-form 20 to a mold 22 having dimensions that correspond to the intended shape of the part that is manufactured. This step is generally indicated at reference numeral 240. The mold 22 is then closed, as indicated at reference numeral 250, preferably under the application of pressure, such that the pre-form 20 adopts the shape and geometry defined by the molding cavity, i.e. the intended shape of the part that is manufactured (at least its general shape; further post-processing steps on the demolded part may follow, which may also further alter the shape and geometry of the part). The pre-form 20 is then cured or it is allowed to cure within the mold 22 (the mold pressure may or may not be maintained during the curing), preferably under the application of: heat, UV light and/or ultrasonic waves, and/or under a change in: temperature and/or humidity, as indicated at reference numeral 260. Finally, as indicated at reference numeral 270, the mold 22 is opened and the molded part 21 of a luggage system is removed from the mold 22. After the demolding step 270, further processing may occur, as already indicted above, e.g., the part 21 may be trimmed or post-processed, holes or further component may be added, and so forth.

The method 300 illustrated in FIG. 3 again starts, generally indicated by reference numeral 310, by providing input materials to a production site for the preparation of a pre-form 30 for the manufacture of the luggage part 31. The step 310 of providing the input materials this time comprises providing one or more plies of unidirectional natural fibers. The method further comprises layering up the plies to form a stack of one or more layers of unidirectional fibers, the unidirectional fibers of each layer being arranged along a respective axis. This step is generally indicated by reference numeral 320 in FIG. 3. Uncured matrix material is applied to the plies of unidirectional fibers and/or to the layered stack, as generally indicated by reference numeral 330 in FIG. 3, and is allowed to be at least partially absorbed by the natural fibers to form the pre-form 30. It is emphasized that the sequence of the steps 320 and 330 may also be different to the situation shown here, i.e., the uncured matrix material may also be provided prior to or during stacking up of the layers in step 320.

Moreover, the method 300 may also comprise the step of fusing the locations where fibers of the different plies or layers cross or overlap within the stack under the application of: pressure, heat, UV light and/or ultrasonic waves (not shown in FIG. 3).

From there, the method 300 may proceed in a similar manner as the method 200 described above: The pre-form 30 provided as just described may be heated (the heating may also occur, at least partially, within the mold 32 and/or during closing of the mold 32, or be omitted completely if not necessary to make or keep the pre-form 30 malleable) and the pre-form 30 is then transferred to a mold 32 having dimensions that correspond to the intended shape of the part that is manufactured. This step is generally indicated at reference numeral 340. The mold 32 is then closed, as indicated at reference numeral 350, preferably under the application of pressure, such that the pre-form 30 adopts the shape and geometry defined by the molding cavity, and hence the intended shape of the part that is manufactured (again, further post-processing of the demolded part may yet occur). The pre-form 30 is then cured or it is allowed to cure within the mold 32 (again, the mold pressure may or may not be maintained during the curing), preferably under the application of: heat, UV light, and/or ultrasonic waves, and/or under a change in: temperature and/or humidity, as indicated at reference numeral 360. Finally, as indicated at reference numeral 370, the mold 32 is opened and the molded part 31 of a luggage system is removed from the mold 32. After the demolding step 370, further processing may again occur, e.g., the part 31 may be trimmed or post-processed, holes or further component may be added, and so forth.

The duration and processing parameters for the different steps of the thermoforming/molding operation, i.e., the steps 240-270 and 340-370, can depend, for example, on the physical dimensions and press capabilities of the molding equipment and the materials used for the manufacture. For example, the duration of the mold closing step 250, 350 may depend on the press capabilities (e.g., maximal closure pressure) and the impregnation behavior of the natural fibers contained in the pre-form 20, 30, while the duration of the curing step 260, 360 may depend on the chemical composition of the matrix material, the curing temperature within the mold, the duration and amount of pressure exerted during the preceding step 250, 350, the mold pressure during curing, and so forth.

Some of the steps provided by the methods 200, 300 for the manufacture of a part of a luggage system may also be utilized, potentially in a slightly modified version, to provide for a method of repairing a damaged part of a luggage system.

Such a method may comprise adding uncured matrix material to the damaged area of the part and allowing the natural fiber material in the damaged area to absorb the added uncured matrix material at least partially (e.g., similar to step 330 of the method 300).

Pressure may then be applied to the damaged area, for example within a mold (e.g., similar to step 250 of the method 200 or to step 350 of the method 300) or in a different manner.

The repair process may further include curing the added uncured matrix material or allowing it to cure, during, after or without the application of pressure, and preferably under the application of: heat, UV light and/or ultrasonic waves, and/or under a change in: temperature and/or humidity (e.g., similar to step 260 of the method 200 or step 360 of the method 300).

FIG. 4 shows a part 400 of a luggage system made from a fiber-reinforced material as disclosed herein. The part may be used, for example, as a front or back insert for the main face of a shell of a hard-shell case or trolley, like the trolley 500 discussed below. The fiber-reinforced material is made from a natural fiber material and a matrix material, wherein the natural fiber material comprises two sets of unidirectional natural fibers provided in the form of fibrous yarns that are woven to a bi-axial woven fabric. This fabric is embedded within and impregnated with the matrix material.

In the part 400 shown in FIG. 4, a bi-axial natural fiber material 410 using flax fibers is used in combination with a thermoset epoxy resin as matrix material.

At the bottom of FIG. 4, a similar part 405 is shown after demolding (e.g., after step 270 of the method 200 or step 370 of the method 300), but before being trimmed to its final dimensions, to make the woven structure of the included bi-axial flax-fiber material 410 more apparent.

Finally, FIGS. 5a-h show a luggage system, namely a travel- or cabin trolley 500, making use of a fiber-reinforced material as disclosed herein, for example one of the materials 100a, 100b or 100c discussed above.

The trolley 500 generally consists of a front shell 510 and a back shell 520, which are connected to each other in such a manner that the two shells 510, 520 can be opened and closed upon each other. The trolley 500 further comprises a closure means, in the embodiment shown here a zipper mechanism 530, from securing the two shells 510, 520 in their closed position.

The trolley 500 further comprises four spinning wheels 540 mounted in respective indentations 545 at the four bottom corners of the front and back shells 510, 520.

The trolley 500 also comprises a retractable handle-bar system 550 for pulling the trolley 500 along on its wheels, as well as a side grip arrangement 560 for carrying the trolley 500 by hand.

Beneath the handle-bar system 550, a recess or storage space 570 may be arranged, which is accessible when the handle-bar system 550 is in its protracted position (see FIG. 5d), and in which, for example, an USB powerbank may be releasable stored. Express reference is made at this position to the disclosure in the applicant's previous applications DE 20 2017 101 957 U1 and WO 2018 185016 A1, the disclosure of which is herewith incorporated in regard to the handle-bar system 550 and storage space 570 of the trolley 500.

FIG. 5a shows the front shell 510 without any of the additional components (wheels, handle-bar system, zipper, etc.), FIG. 5b shows the back shell 520 without any of the additional components. Either or both of these shells 510, 520 may be made in the inventive manner, i.e. using an embodiment of the disclosed fiber-reinforced material based on natural fibers, like the material 100a, 100b or 100c discussed above. Preferable, both shells 510 and 520 are made from such a material.

FIG. 5c shows a front view of the entire trolley 500 with all of the further components added, and FIG. 5d a back view of the entire trolley 500, in both cases with the handle-bar system 550 in protracted or pulled-out position.

FIG. 5e shows the right-hand side face (in relation to the front face) of the trolley 500 with all of the further components added, and FIG. 5f the left-hand side face. Finally, FIG. 5g shows the top of the trolley with all of the further components added and with the handle-bar system 550 in its contracted or pushed-in position, and FIG. 5h shows a bottom view.

Besides the front and back shell 510 and 520, any or all parts of the trolley 500 may comprise or be based on the disclosed fiber-reinforced material, or be made of such a material.

In this manner, the disclosed materials and methods may allow for the provision of a trolley 500 free from aluminum, or at least with a significantly reduced amount of aluminum, and completely or at least predominately based on natural and biodegradable materials. This lessens the environmental footprint left by the luggage system 500 both at the beginning and the end of its lifespan.

### ADDITIONAL EMBODIMENTS

The following paragraphs describe additional embodiments.

In some embodiments, a method is utilized for the manufacture of a part of a luggage system. The method includes providing a pre-form, heating the pre-form and transferring (240; 340) the pre-form to a mold (22; 32) having dimensions that correspond to the intended shape of the part; closing the mold (250; 350), preferably under the application of pressure, such that the pre-form adopts the intended shape of the part; curing (260; 360) the pre-form or allowing it to cure, preferably under the application of: heat, UV light and/or ultrasonic waves, and/or under a change in: temperature and/or humidity; and opening (270; 370) the mold and demolding the part.

In some embodiments, providing the pre-form includes the steps of providing (310) one or more plies of unidirectional natural fibers; and layering up (320) the plies to form a stack of one or more layers of unidirectional fibers, the unidirectional fibers of each layer being arranged along a respective axis. Uncured matrix material may be applied (330) to the plies of unidirectional fibers and/or to the layered stack and may be allowed to be at least partially absorbed by the natural fibers to form the pre-form.

In some embodiments, providing the pre-form further includes fusing the locations where fibers of the different plies or layers cross or overlap within the stack under the application of: pressure, heat, UV light and/or ultrasonic waves.

In some embodiments, providing the pre-form includes the steps of providing (210) at least one natural fiber material in the form of a woven multi-axial fabric; providing (210) at least one uncured matrix material in the form of a ribbon, sheet or film; and laminating (220) the natural fiber material with the uncured matrix material, preferably under the application of: heat and/or pressure, and allowing the natural fiber material to a least partially absorb the uncured matrix material to form the pre-form.

In some embodiments, a method is described for the repair of a part of a luggage system that has been damaged. The method may include adding uncured matrix material to the damaged area of the part; allowing the natural fiber material in the damaged area to absorb the added uncured matrix material at least partially; applying pressure to the damaged area; and curing the added uncured matrix material or allowing it to cure, preferably under the application of: heat, UV light and/or ultrasonic waves, and/or under a change in: temperature and/or humidity.

In some embodiments, a method is described for the repair of a part of a luggage system that has been damaged. The method may include adding uncured matrix material to the damaged area of the part; allowing the natural fiber material in the damaged area to absorb the added uncured matrix material at least partially; and

curing the added uncured matrix material or allowing it to cure, preferably under the application of: pressure, heat, UV light and/or ultrasonic waves, and/or under a change in: temperature and/or humidity.

1. A shell of a luggage system, the shell comprising a fiber-reinforced material, wherein the fiber-reinforced material comprises:
a natural fiber material; and
a matrix material, wherein
the natural fiber material comprises at least one set of unidirectional fibers which are embedded in and/or impregnated with the matrix material.

2. The shell of claim 1, wherein the natural fiber material comprises n sets of unidirectional fibers which are embedded in and/or impregnated with the matrix material, wherein n is an integer number greater than 1, and wherein the n sets of unidirectional fibers are mutually non-parallel.

3. The shell of claim 2, wherein each set of unidirectional fibers comprises a plurality of fiber bundles and/or fibrous yarns that are arranged along a respective axis.

4. The shell of claim 2, wherein n=2 and the natural fiber material is provided as a bi-axial fabric.

5. The shell of claim 4, wherein the two axes of the bi-axial fabric intersect at an oblique angle.

6. The shell of claim 2, wherein n=3 and the natural fiber material is provided as a tri-axial fabric.

7. The shell of claim 6, wherein at least two of the axes of the tri-axial fabric intersect at an angle different from 60°.

8. The shell of claim 1, wherein the unidirectional fibers are continuous.

9. The shell of claim 1, wherein the natural fiber material is provided as a layered fabric.

10. The shell of claim 9, wherein each layer comprises several plies of parallel-oriented, unidirectional fibers.

11. The shell of claim 1, wherein the natural fiber material is provided as a woven fabric.

12. The shell of claim 1, wherein the natural fiber material comprises fibers of one or more of the following materials: leaf fibers, bast fibers, or stalk fibers.

13. The shell of claim 1, wherein a material composition of the natural fiber material varies within a given set of unidirectional fibers and/or between at least two sets of unidirectional fibers.

14. The shell of claim 1, wherein one or more physical properties vary within a given set of unidirectional fibers and/or between at least two sets of unidirectional fibers, wherein the one or more physical properties include one or both of a gauge of the unidirectional fibers and a linear mass density of the unidirectional fibers.

15. The shell of claim 1, wherein the matrix material is biodegradable and/or comprises recycled material.

16. The shell of claim 1, wherein the matrix material comprises one of more of the following materials: an amorphic, crystalline or semicrystalline thermoset resin; an amorphic, crystalline or semicrystalline thermoplastic resin; or a film of any of the beforementioned thermoset of thermoplastic materials or combinations thereof.

17. The shell of claim 1, wherein the shell is free from aluminum.

18. The shell of claim 1, wherein the luggage system comprises a hardshell case or a trolley.

19. A luggage system, comprising:
a shell comprising a fiber-reinforced material, wherein the fiber-reinforced material comprises:
a natural fiber material; and
a matrix material, wherein the natural fiber material comprises at least one set of unidirectional fibers which are embedded in and/or impregnated with the matrix material.

20. A part of a luggage system,
wherein the part comprises a fiber-reinforced material, wherein the fiber-reinforced material comprises:
a natural fiber material; and
a matrix material, wherein the natural fiber material comprises at least one set of unidirectional fibers which are embedded in and/or impregnated with the matrix material.

21-23. (canceled)
